(19) United States
(12) Patent Application Publication
(10) Pub. No.: US 2026/0205348 A1
(43) Pub. Date: Jul. 16, 2026

(54) NETWORK MANAGEMENT APPARATUS, METHOD, AND PROGRAM

(71) Applicant: NTT, Inc., Tokyo (JP)

(72) Inventors: Masashi KOBAYASHI, Tokyo (JP); Shunsuke KANAI, Tokyo (JP); Hiroaki MATSUBAYASHI, Tokyo (JP); Kazuaki AKASHI, Tokyo (JP); Mayu YAMAZOE, Tokyo (JP)

(73) Assignee: NTT, Inc., Tokyo (JP)

(21) Appl. No.: 19/131,972

(22) PCT Filed: Dec. 5, 2022
(86) PCT No.: PCT/JP2022/044735

§ 371 Date: May 22, 2025

(51) Int. Cl. H04L 41/0668; H04L 41/0659; H04L 41/0816

(52) U.S. Cl. CPC H04L 41/0668; H04L 41/0661; H04L 41/0816

(57) ABSTRACT

A network management device includes a failure influence calculation unit configured to calculate, for each of a plurality of buildings corresponding to an upper layer of a network, an influence of a failure in communication including an occurring failure and an influence of the occurring failure on another building corresponding to a lower layer of the network when a condition that the failure occurs in communication in one of the buildings corresponding to the upper layer of the network and each accommodating a communication facility is applied. Further, there is a priority calculation unit configured to calculate, for each combination of a plurality of buildings in which the failure has occurred. A priority of a candidate for a building to be restored is applied on the basis of the influence calculated by the failure influence calculation unit.

### TECHNICAL FIELD

An embodiment of the present invention relates to a network management device, a method, and a program.

### BACKGROUND ART

In a building (which may referred to as a communication building) in which a communication facility is accommodated to provide communication to the outside, in a case where communication in this building is disconnected because power supply from a power plant is interrupted due to occurrence of a disaster such as an earthquake or a typhoon, or the like, provision of communication is resumed by operating an emergency power generator or the like, which is operated by fuel, installed in the building so as to restore the power supply.

When the above emergency power generator is operated for a long time and the fuel stored in the building is exhausted, the operation of the emergency power generator is stopped, and thus power supply is interrupted again, thereby disconnecting the communication. Therefore, a telecommunications carrier delivers and supplies fuel to the above communication building by a vehicle or the like.

The telecommunications carrier needs to deliver fuel to the communication building before the fuel is exhausted or to promptly deliver fuel to the communication building in which the fuel has been exhausted by using a fuel delivery vehicle so as to early resume provision of communication.

In order to reduce an influence of the communication disconnection as much as possible under a condition of limited fuel resources, the telecommunications carrier needs to quickly select a building to be recovered, to which fuel is to be delivered, from among a large number of communication buildings in which the above fuel has been exhausted among communication buildings in which power supply has been interrupted.

The building to be recovered needs to be selected according to various situations such as a disaster-stricken building, an influence on a communication network service spread from the building, a location, a fuel situation, and a traffic situation, and it takes a lot of time and high-level skills for manual consideration.

Since a response to a disaster is urgent, a frequency of occurrence thereof is low, and it is difficult to train skilled people, there is a need for a technique of selecting a building to be recovered in view of the situation at the time of disaster and automatically and quickly determining a fuel delivery plan to the building.

For example, a technique is disclosed in which network configuration information and failure influence information are required, and a building to be preferentially recovered among buildings is evaluated on the basis of the failure influence information, so that the above delivery plan can be determined (e.g., refer to Non Patent Literatures 1 and 2).

Moreover, since the spreading influence differs depending on the combination of buildings in which a failure has occurred at the time of disaster, the evaluation of the service influence and the allocation plan using the weight (policy) of each influence item can be calculated on the basis of blackout building information and social information for all possible combination patterns of the buildings.

### CITATION LIST

### Non Patent Literature

Non Patent Literature 1: Hiroaki Matsubayashi, Masataka Sato, Kenji Murase, Shunsuke Kanai, Kazuaki Akashi, Shohei Nishikawa, Manami Ogawa, and Kenichi Tayama, “Network Topology wo Koryo Shita Kyusai Biru Yusen Juni no Sanshutsu (A Study on Relief Building Priority Considering the Network Topology)” The Institute of Electronics, Information and Communication Engineers (IEICE)
Non Patent Literature 2: Masataka Sato, Shohei Nishikawa, Kimihiko Fukami, Kenji Murase, and Kenichi Tayama, “Technology for Understanding Service Impact Using Network Resource Management Technology that Is Independent of Network Type”, NTT Technical Review, Internet <URL: https://journal.ntt.co.jp/wp-content/uploads/2020/07/JN20200851.pdf>

### SUMMARY OF INVENTION

### Technical Problem

As described above, when the service influence is evaluated for all possible combination patterns of buildings in which a failure has occurred and the delivery plan is made, the necessary processing time is a time obtained by multiplying the time required to calculate the service influence for each combination described above by the number of combinations of buildings, and the processing time becomes enormous according to the number of combinations of buildings.

The present invention has been made in view of the above circumstances, and an object thereof is to provide a network management device, a method, and a program that make it possible to specify an object of restoration from the failure in an appropriate processing time when a communication failure occurs in a network configuration.

### Solution to Problem

A network management device according to an aspect of the present invention includes: a failure influence calculation unit configured to calculate, for each of a plurality of buildings corresponding to an upper layer of a network, an influence of a failure in communication including an occurring failure and an influence of the occurring failure on another building corresponding to a lower layer of the network when a condition that the failure occurs in communication in one of the buildings corresponding to the upper layer of the network and each accommodating a communication facility is applied; and a priority calculation unit configured to calculate, for each combination of a plurality of buildings in which the failure has occurred, a priority of a candidate for a building to be restored from the failure among a plurality of buildings when a condition that the failure occurs in communication in the plurality of buildings corresponding to the upper layer is applied on the basis of the influence calculated by the failure influence calculation unit.

A network management method according to an aspect of the present invention is a method performed by a network management device, the method including: calculating, for each of a plurality of buildings corresponding to an upper layer of a network, an influence of a failure in communication including an occurring failure and an influence of the occurring failure on another building corresponding to a lower layer of the network when a condition that the failure occurs in communication in one of the buildings corresponding to the upper layer of the network and each accommodating a communication facility is applied; and calculating, for each combination of a plurality of buildings in which the failure has occurred, a priority of a candidate for a building to be restored from the failure among a plurality of buildings when a condition that the failure occurs in communication in the plurality of buildings corresponding to the upper layer is applied on the basis of the calculated influence.

### Advantageous Effects of Invention

According to the present invention, when a communication failure occurs in a network configuration, an object of restoration from the failure can be specified in an appropriate processing time.

### BRIEF DESCRIPTION OF DRAWINGS

FIG. 1 is a diagram illustrating an application example of a network management device according to an embodiment of the present invention.

FIG. 2 is a flowchart illustrating an example of a processing procedure by the network management device according to the embodiment of the present invention.

FIG. 3 is a diagram illustrating an example of general calculation of a service influence in a combination of buildings in which a failure has occurred.

FIG. 4 is a diagram for explaining an example of functions of a priority calculation unit and an allocation plan processing unit.

FIG. 5 is a diagram illustrating an example of calculation of a single building priority.

FIG. 6 is a diagram illustrating an example of calculation of a single building priority in a table format.

FIG. 7 is a block diagram illustrating an example of a hardware configuration of the network management device according to the embodiment of the present invention.

### DESCRIPTION OF EMBODIMENTS

Hereinafter, an embodiment according to the present invention will be described with reference to the drawings.

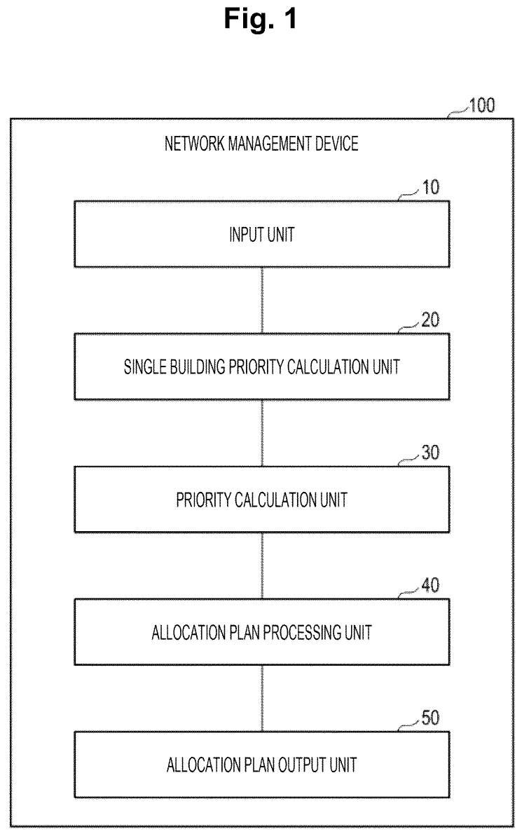

FIG. 1 is a diagram illustrating an application example of a network management device according to the embodiment of the present invention.

As illustrated in FIG. 1, a network management device 100 according to the embodiment of the present invention includes an input unit 10, a single building priority calculation unit (failure influence calculation unit) 20, a priority calculation unit (combination priority calculation unit) 30, an allocation plan processing unit 40, and an allocation plan output unit 50.

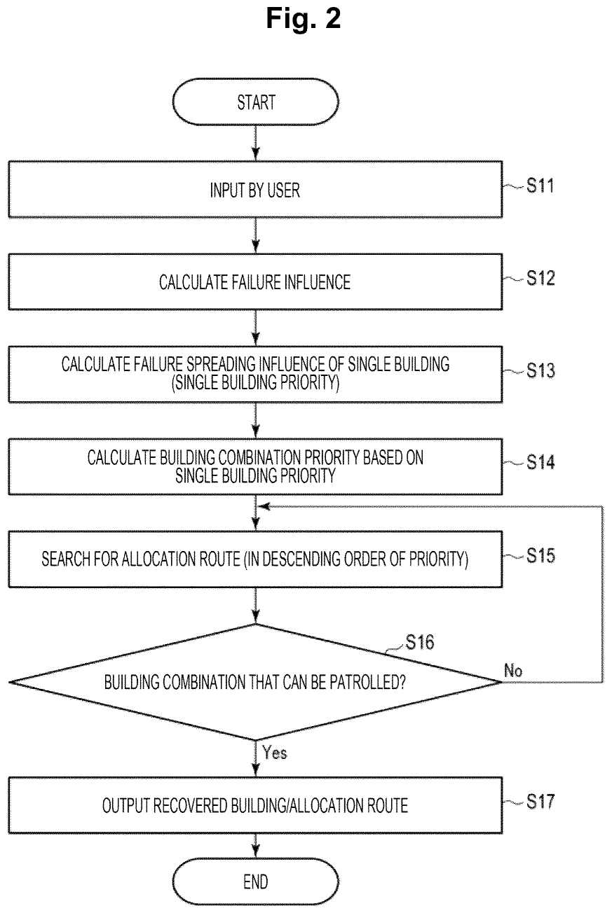

FIG. 2 is a flowchart illustrating an example of a processing procedure by the network management device according to the embodiment of the present invention.

The input unit 10 inputs failure information indicating a communication failure (which may be simply referred to as a failure) occurring in any of a plurality of buildings forming a network configuration, for example, a network redundancy configuration and each accommodating a communication device, a power supply situation related to restoration from the occurring communication failure, and vehicle allocation information related to a candidate for a vehicle (which may be hereinafter referred to as a restoration work vehicle) to be used for a work of restoring communication in a building in which a communication failure has occurred (S11).

The above power supply situation is, for example, a situation of power supply to an emergency power supply, which will be described later, accommodated in each building, an elapsed time from occurrence of a communication failure in each building, and the like. Moreover, the above vehicle allocation information is, for example, a current position of a candidate for the restoration work vehicle, the number of restoration work vehicles that can move to the building, a type of the restoration work vehicle, and an amount of fuel for the emergency power generator that can be transported and supplied by each restoration work vehicle.

For example, the input unit 10 can input, as the failure information, a connection relationship of buildings in the network redundancy configuration, a type of an emergency power supply in each building, a location of each building, information indicating an influence when a communication failure occurs in each building, and the like regarding each building constituting the redundancy configuration of the communication network to which communication is provided in S11 by an input operation by an operator or the like.

The provision of communication in a building means, for example, communication between communication devices in the building, and communication between a communication device in the building and an external communication device.

Examples of the above communication failure include disconnection of communication due to interruption of power supply to the communication facility in a building, or disconnection of communication due to breakdown of a communication device such as a server or damage to a communication cable. In the following description of the present embodiment, disconnection of communication due to interruption of power supply to the communication facility in a building will be described as an example.

Moreover, examples of the type of the emergency power supply in each building described above include an emergency power generator operated by fuel, and an emergency power supply device operated by a chargeable and dischargeable storage battery. The emergency power generator is, for example, a diesel engine.

Note that the above building may have another form as long as the building is a facility for which communication is provided.

The above connection relationship of buildings may include, for example, information indicating an upper layer (which may be simply referred to as a higher order) and a lower layer (which may be simply referred to as a lower order) in a network topology. Examples of the above information indicating the influence at the time of a communication failure include the number of users (which may be referred to as accommodated users) who can be accommodated in a building in which a communication failure has occurred and utilize communication, the number of communication devices installed in the building, and the amount of data transmitted and received by the communication devices installed in the building.

Moreover, the input unit 10 can input the traffic situation of a traveling area of each vehicle related to the candidate for the restoration work vehicle as the vehicle allocation information in S11 by the above input operation or the like. Examples of the traffic situation include information indicating a traffic volume in the above traveling area, and information indicating whether a road is passable due to construction work or disaster or not.

Examples of the type of vehicle in the above vehicle allocation information include a fuel delivery vehicle and a power supply vehicle.

The fuel delivery vehicle is loaded with fuel for the emergency power generator when the emergency power supply in the building is the above emergency power generator, and includes a facility that fills the emergency power generator with the fuel.

Moreover, in a case where the emergency power supply in the building is the above emergency power supply device, the above power supply vehicle is a vehicle including a charging device for charging the above storage battery, or a vehicle including a replacement storage battery in a case where the above storage battery is replaceable, that is, a vehicle to be loaded with a new charged storage battery.

On the basis of the failure information inputted in S11, the single building priority calculation unit 20 uses, for example, a failure influence calculation function of a network operation injected model (NOIM) disclosed in Non Patent Literature 2 described above to calculate, for each building, a communication failure that has occurred due to, for example, a stop of power supply to a communication facility accommodated in a single building in a network configuration, and a communication failure spreading influence that is an influence of the communication failure on another building in the same network configuration (S12).

For example, on the basis of the information inputted by the input unit 10, the single building priority calculation unit 20 can specify a plurality of buildings in a lower order of the network topology whose communication is disconnected due to the influence of the occurrence of a communication failure in a plurality of buildings in a higher order of the network topology among the buildings in the network redundancy configuration.

The single building priority calculation unit 20 utilizes the network topology to calculate a single building priority (which may be referred to as a single building priority score) that is the magnitude of the influence on the communication service including the magnitude of the communication failure of the single building on the basis of the spreading influence at the time of communication failure of the above single building (S13).

The single building priority is obtained according to, for example, a situation of a communication failure and a spreading influence on another building under a condition that a failure related to power supply to a communication facility accommodated in the single building, that is, a communication failure is assumed to have occurred.

In the present embodiment, the above single building priority can be calculated in consideration of “communication disabled”, “communication enabled”, and “intermediate influence state in which some communication is affected” as the spreading influence from the single building in which the above failure has occurred.

In the present embodiment, the time required for calculating the priority of the building to be recovered is greatly reduced by replacing the priority of a building to be recovered whose communication function is to be restored with the spreading influence under the condition of the combination of the buildings in which the communication failure occurs, for example, the absolute value of the number of users affected and using the calculation result of the above single building priority.

In the present embodiment, since the spreading influence is calculated by utilizing the network topology for each single building, the magnitude of the service influence including a building related to the building in which the communication failure has occurred can be evaluated without performing calculation for each possible combination pattern of objects to be patrolled, the processing time is not affected even if the number of the combination patterns described above increases, and advance calculation is also possible.

In the present embodiment, calculation can be achieved only by performing superimposition processing on the calculated single building priorities, and the processing time is shortened.

In the present embodiment, by using the single building priorities, it is possible to simplify the investigation regarding the spreading influence of the communication failure after the combination extraction of the buildings in which the communication failure has occurred. Therefore, the processing time of the combination of the buildings to be recovered can be reduced, and the combination of the buildings to be recovered can be extracted in descending order of the above single building priority.

Next, an example of evaluation of a failure influence by a general method not according to the present embodiment will be described.

Since the spreading influence of the communication failure, that is, the number of users affected by the communication failure varies depending on the combination of the buildings in which the communication failure occurs, it is necessary to calculate the service influence in the entire network for each combination pattern of the buildings in which the failure has occurred. As the number of object buildings increases, the number of combination patterns described above rapidly increases, and therefore the total processing time related to the calculation of the service influence becomes longer.

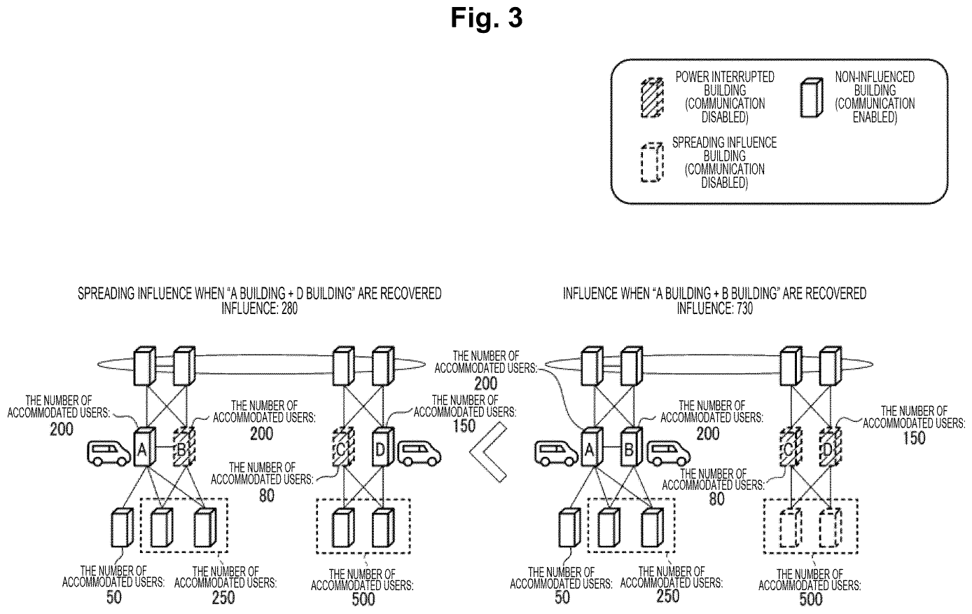

FIG. 3 is a diagram illustrating an example of general calculation of a service influence in a combination of buildings in which a failure has occurred.

FIG. 3 illustrates an example in which there are a plurality of buildings capable of communicating with both of “A building” and “B building” and a building capable of communicating with “A building”, which are located in a lower layer than “A building” and “B building” corresponding to upper layer in the network, and there are a plurality of buildings, which is capable of communicating with both of “C building” and “D building” and are located in a lower order than “C building” and “D building”.

In this example, network redundancy is secured by a plurality of buildings in which communication devices are mounted, such as “A building” and “B building” illustrated in FIG. 3, or “C building” and “D building” illustrated in FIG. 3. In such a configuration, even when a communication failure occurs only in a building on one side forming redundancy, a spreading communication influence (which may also be referred to as a spreading influence) on a building in a lower order does not occur if a communication failure does not occur in a building on the other side.

On the other hand, when a communication failure occurs in both of the plurality of buildings having the above redundancy, a spreading communication influence occurs in a building in a lower order according to the configuration of the network topology.

FIG. 3 illustrates an example in which a communication failure occurs in “A building”, “B building”, “C building”, and “D building”, and the communication function is restored with “A building” and “D building” among these buildings as the objects of recovery as a first example, and an example in which the communication function is restored with “A building” and “B building” among “A building”, “B building”, “C building”, and “D building” in which a communication failure has occurred as the objects of recovery as a second example.

When the communication function is restored with “A building” and “D building” as the objects of recovery as in the first example, the number of people 280, which is the total of the number of people (the number of accommodated users) 200 accommodated in “B building” that is not an object of recovery and the number of people 80 accommodated in “C building” that is also not an object of recovery, is calculated as the number of users affected by the communication failure including the spreading influence (the number of affected users).

In this example, no spreading communication influence occurs for buildings in a lower order than “A building” and “B building”, and buildings in a lower order than “C building” and “D building”.

Moreover, when the communication function is restored with “A building” and “B building” as the objects of recovery as in the second example, the number of people 730, which is the total of the number of people 80 accommodated in “C building” that is not an object of recovery, the number of people 150 accommodated in “D building” that is also not an object of recovery, and the total number of people 500 accommodated in a plurality of buildings that is located in a lower order than “C building” and “D building” and are capable of communicating with both of these “C building” and “D building”, is calculated as the number of users affected by the communication failure including the spreading influence. In this example, a spreading communication influence does not occur for buildings in a lower order than “A building” and “B building”, while a spreading communication influence occurs for buildings in a lower order than “C building” and “D building”.

That is, when a failure occurs in “A building”, “B building”, “C building”, and “D building” illustrated in FIG. 3, the failure influence in the entire network is smaller when “A building” and “D building” are the objects of recovery than when “A building” and “B building” are the objects of recovery.

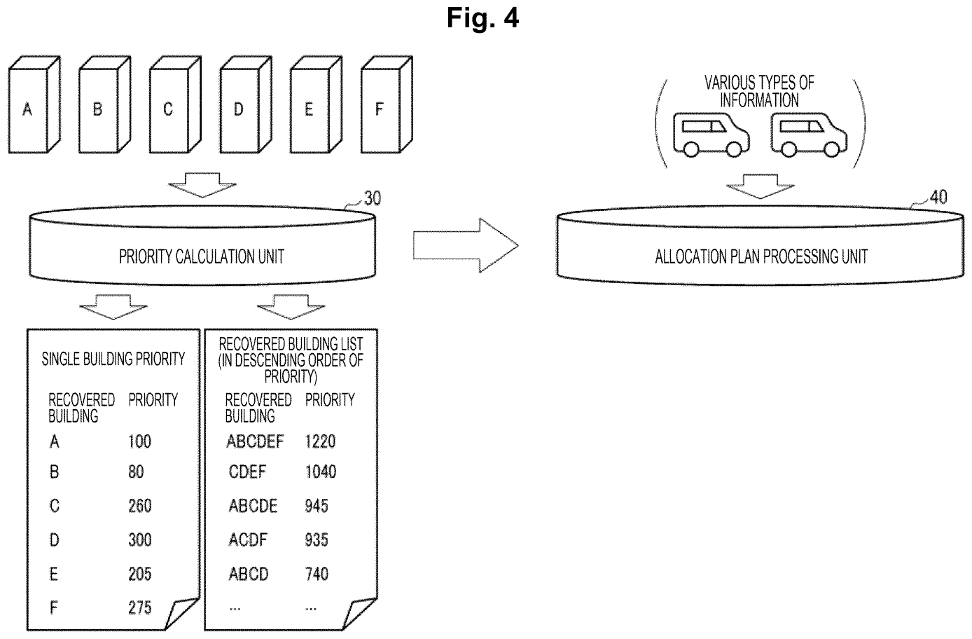

FIG. 4 is a diagram for explaining an example of functions of a priority calculation unit and an allocation plan processing unit.

The priority calculation unit 30 calculates the priority related to the restoration from the communication failure for each combination pattern of buildings in which the above communication failure has occurred on the basis of the single building priority of each of the buildings in which the communication failure has occurred (S14).

In the example illustrated in FIG. 4, the buildings in which the communication failure has occurred are “A building”, “B building”, “C building”, “D building”, “E building”, and “F building”.

It is assumed that the single building priority that is the total failure influence of the number of users accommodated in a building in which a communication failure has occurred and the number of users affected by the communication failure based on the number of users accommodated in another building in which a communication failure has occurred, which is a spreading influence from the communication failure, on an assumption that the communication failure has occurred in the single building among the above buildings is calculated by the single building priority calculation unit 20 as “single building priority of A building: 100 people”, “single building priority of B building: 80 people”, “single building priority of C building: 260 people”, “single building priority of D building: 300 people”, “single building priority of E building: 205 people”, and “single building priority of F building: 275 people” as illustrated in FIG. 4, for example.

Then, the priority calculation unit 30 can obtain the restoration priority for the combination of buildings to be recovered for each combination pattern on the basis of each single building priority. For example, as illustrated in FIG. 4, the priority calculation unit 30 can find that the priority related to a combination including a total of six buildings from “A building” to “F building” is “1220”, the priority related to a combination including a total of four buildings from “C building” to “F building” is “1040”, the priority related to a combination including a total of five buildings from “A building” to “E building” is “945”, the priority related to a combination including a total of four buildings of “A building”, “C building”, “D building”, and “F building” is “935”, and the priority related to a combination including a total of four buildings from “A building” to “D building” is “740”.

Among the above combinations, a combination having a higher priority, that is, a combination having a larger number of accommodated users affected by a communication failure is a combination having a higher effect of work related to restoration, and thus, has a higher priority related to implementation of work related to restoration.

The allocation plan processing unit 40 determines, in descending order of the priority calculated by the priority calculation unit 30, whether to allocate and patrol a candidate for a restoration work vehicle that is a vehicle to be directed to a work of restoring a communication failure to each building belonging to a combination pattern of buildings related to this priority or not for each combination pattern of buildings forming a redundant configuration of the network on the basis of the location of each building in which the communication failure has occurred, the power supply situation, the traffic situation of the vehicle allocation information, and the like inputted in S11, thereby searching for a restoration work vehicle for each building in a pattern according to the priority and an allocation route that is an appropriate movement route of this vehicle (S15).

As a result of this determination, when there is a route which enables allocation and patrol of the restoration work vehicle (Y in S16), the allocation plan processing unit 40 generates allocation plan information that is information indicating the restoration work vehicle to be actually directed to a work of restoring the building, a traveling schedule and a traveling route of this vehicle, and the like.

The allocation plan output unit 50 outputs the allocation plan information generated by the allocation plan processing unit 40 by displaying the allocation plan information on a display device (not shown) or the like (S17).

In the present embodiment, on the basis of the number of accommodated users when a communication failure occurs in a single building, an allocation plan of restoration work vehicles is generated for each combination pattern of buildings forming a redundant configuration of a network in which a communication failure has occurred, whereby an appropriate allocation plan of the restoration work vehicles is generated.

Therefore, for example, it is possible to automatically and quickly determine the allocation plan capable of greatly shortening a time during which the communication failure is occurring in the building to be restored from the communication failure, and thus it is possible to eliminate a need for high-level skills related to allocation planning and to greatly shorten a time required for the planning.

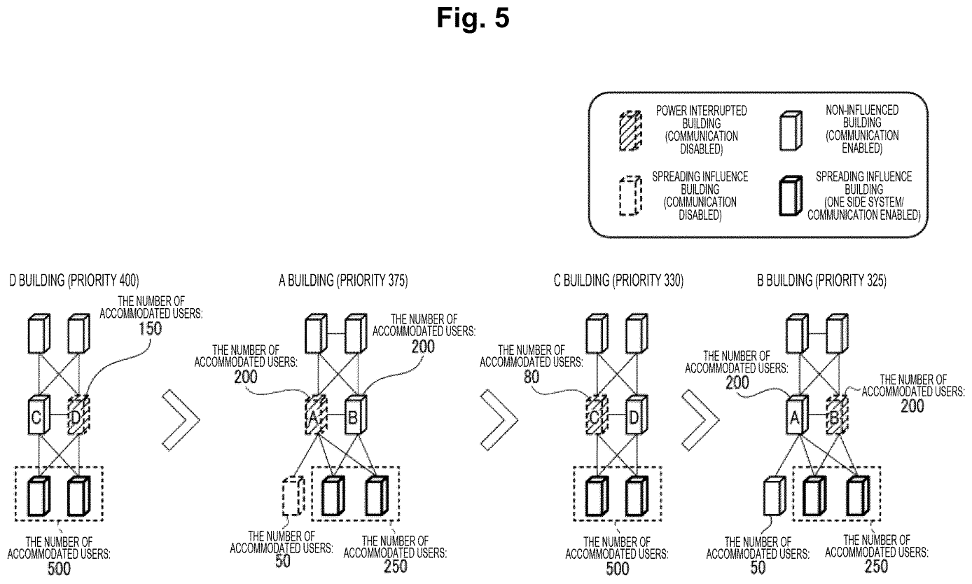

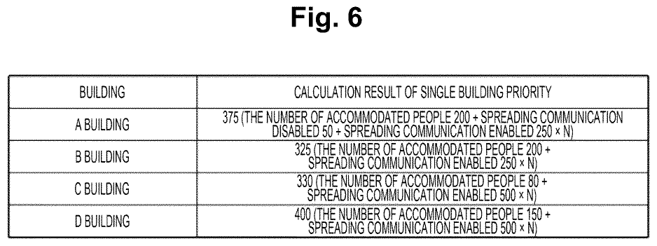

Next, a specific example of calculation of the above single building priority will be described. FIG. 5 is a diagram illustrating an example of calculation of a single building priority. FIG. 6 is a diagram illustrating an example of calculation of a single building priority in a table format.

FIG. 5 illustrates an example of calculation of a single building priority when a failure occurs in “A building”, a single building priority when a failure occurs in “B building”, a single building priority when a failure occurs in “C building”, and a single building priority when a failure occurs in “D building” by the single building priority calculation unit 20.

Here, first, when a failure occurs in “A building”, a number “375” obtained by adding the number of users “200” accommodated in “A building”, the number of users “50” accommodated in one building that can communicate only with “A building” among three buildings in a lower order than “A building”, that is, that does not communicate with “B building” forming redundancy with “A building”, and the number of users “125” obtained by multiplying the number of users “250” accommodated in two buildings that can communicate with both of “A building” and “B building” in a lower order than “A building” and “B building” forming redundancy by a coefficient “0.5” of conversion into the number of users affected by the failure that has occurred in “A building” is calculated by the single building priority calculation unit 20 as the single building priority when a failure occurs in “A building”.

Second, when a failure occurs in “B building”, a number “325” obtained by adding the number of users “200” accommodated in “B building”, and the number of users “125” obtained by multiplying the number of users “250” accommodated in two buildings that can communicate with both of “A building” and “B building” in a lower order than “A building” and “B building” forming redundancy by a coefficient “0.5” of conversion into the number of users affected by the failure that has occurred in “B building” is calculated by the single building priority calculation unit 20 as the single building priority when a failure occurs in “B building”.

Third, when a failure occurs in “C building”, a number “330” obtained by adding the number of users “80” accommodated in “C building”, and the number of users “250” obtained by multiplying the number of users “500” accommodated in two buildings that can communicate with both of “C building” and “D building” in a lower order than “C building” and “D building” forming redundancy by a coefficient “0.5” of conversion into the number of users affected by the failure that has occurred in “C building” is calculated by the single building priority calculation unit 20 as the single building priority when a failure occurs in “C building”.

Fourth, when a failure occurs in “D building”, a number “400” obtained by adding the number of users “150” accommodated in “D building”, and the number of users “250” obtained by multiplying the number of users “500” accommodated in two buildings that can communicate with both of “C building” and “D building” in a lower order than “C building” and “D building” forming redundancy by a coefficient “0.5” of conversion into the number of users affected by the failure that has occurred in “D building” is calculated by the single building priority calculation unit 20 as the single building priority when a failure occurs in “D building”.

As a result of these calculations, the single building priority related to “D building” is the highest, and the single building priority related to “A building”, the single building priority related to “C building”, and the single building priority related to “B building” become lower in this order, and therefore the priority of the recovery when one building is to be recovered is in the order of “D building”, “A building”, “C building”, and “B building”.

Then, when a plurality of buildings, two buildings here, are to be recovered, for example, the priority related to the combination of “A building” and “B building” is “700” that is obtained by adding the single building priority related to “A building” and the single building priority related to “B building”, and the priority related to the combination of “A building” and “D building” is “775” that is obtained by adding the single building priority related to “A building” and the single building priority related to “D building”. When these are compared, it is possible to reduce the influence of the failure after the recovery when setting the combination of “A building” and “D building” having higher priority as the object of the recovery.

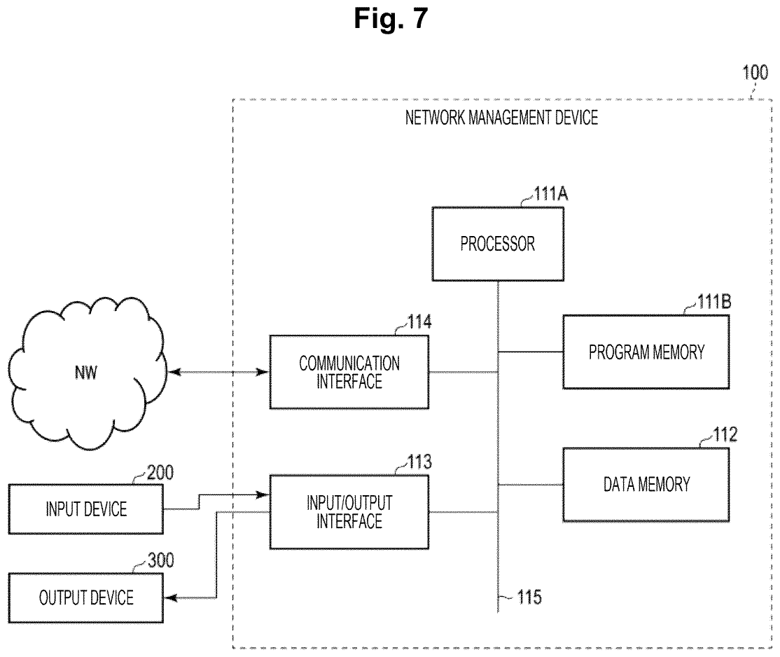

FIG. 7 is a block diagram illustrating an example of a hardware configuration of the network management device according to the embodiment of the present invention.

In the example illustrated in FIG. 7, the network management device 100 according to the above embodiment includes, for example, a server computer or a personal computer, and includes a hardware processor 111A such as a CPU. In addition, a program memory 111B, a data memory 112, an input/output interface 113, and a communication interface 114 are connected with the hardware processor 111A via a bus 115.

The communication interface 114 includes, for example, one or more wireless communication interface units and enables transmission and reception of information to and from a communication network NW. As a wireless interface, for example, an interface is used in which a low-power wireless data communication standard such as a wireless local area network (LAN) is adopted.

The input/output interface 113 is connected with an input device 200 and an output device 300 that are attached to the network management device 100 and are used by a user or the like.

The input/output interface 113 can perform processing of fetching operation data inputted by a user or the like through the input device 200 such as a keyboard, a touch panel, a touchpad, or a mouse, and outputting output data to the output device 300 including a display device using liquid crystal, organic electro luminescence (EL), or the like to make the output data displayed. Note that, as the input device 200 and the output device 300, a device built in the network management device 100 may be used, or an input device and an output device of another information terminal that can communicate with the network management device 100 via the network NW may be used.

The program memory 111B is used as a non-transitory tangible storage medium in, for example, a combination of a non-volatile memory enabling writing and reading at any time, such as a hard disk drive (HDD) or a solid state drive (SSD), and a non-volatile memory such as a read only memory (ROM), and can store programs necessary for executing various types of control processing according to an embodiment.

The data memory 112 is used as a tangible storage medium in, for example, a combination of the above non-volatile memory and volatile memory such as a random access memory (RAM), and can be used to store various types of data or information acquired and created in the process of performing various types of processing.

The network management device 100 according to the embodiment of the present invention can be configured as a data processing device including each unit illustrated in FIG. 1 as a processing functional unit by software.

Information storage units used as work memories or the like by the respective units of the network management device 100 can be configured by using the data memory 112 in FIG. 7. However, those configured storage areas are not essential configurations in the network management device 100 and may be provided in, for example, an external storage medium such as a universal serial bus (USB) memory or a storage device such as a database server arranged in a cloud.

All of the processing function units in each unit described above can be implemented by causing the above hardware processor 111A to read and execute a program stored in the program memory 111B. Note that some or all of these processing function units may be implemented in other various forms including an integrated circuit such as an application specific integrated circuit (ASIC) or a field-programmable gate array (FPGA).

Moreover, the method described in each embodiment can be stored as a program (software means) that can be executed by a computing machine (computer), for example, in a recording medium such as a magnetic disk (Floppy (registered trademark) disk, a hard disk, etc.), an optical disc (a CD-ROM, a DVD, a MO, etc.), or a semiconductor memory (a ROM, a RAM, a flash memory, etc.), and can be distributed by being transmitted through a communication medium. Note that the programs stored in the medium also include a setting program for configuring, in the computing machine, software means (including not only an execution program but also a table and a data structure) to be executed by the computing machine. The computing machine that implements the present device executes the above-described processing by reading the programs recorded in the recording medium, constructing the software means by the setting program as needed, and controlling operation by the software means. Note that the recording medium in the present specification is not limited to a recording medium for distribution, and includes a storage medium such as a magnetic disk or a semiconductor memory provided inside the computing machine or in a device connected via a network.

Moreover, the method described in each embodiment can be stored as a program (software means) that can be executed by a computing machine (computer), for example, in a recording medium such as a magnetic disk (Floppy (registered trademark) disk, a hard disk, etc.), an optical disc (a CD-ROM, a DVD, a MO, etc.), or a semiconductor memory (a ROM, a RAM, a flash memory, etc.), and can be distributed by being transmitted through a communication medium. Note that the programs stored in the medium also include a setting program for configuring, in the computing machine, software means (including not only an execution program but also a table and a data structure) to be executed by the computing machine. The computing machine that implements the present device executes the above-described processing by reading the programs recorded in the recording medium, constructing the software means by the setting program as needed, and controlling operation by the software means. Note that the recording medium in the present specification is not limited to a recording medium for distribution, and includes a storage medium such as a magnetic disk or a semiconductor memory provided inside the computing machine or in a device connected via a network.

Note that the present invention is not limited to the above embodiment, and various modifications can be made in the implementation stage without departing from the gist of the invention. Moreover, embodiments may be implemented in appropriate combination, and in this case, a combined effect can be obtained. Furthermore, the above embodiment includes various inventions, and various inventions can be extracted by a combination selected from a plurality of disclosed components. For example, even if some components are deleted from all the components described in the embodiment, a configuration from which the components have been deleted can be extracted as an invention, as long as the problem can be solved and the effects can be achieved.

### REFERENCE SIGNS LIST

100 Network management device
10 Input unit
20 Single building priority calculation unit
30 Priority calculation unit
40 Allocation plan processing unit
50 Allocation plan output unit

1. A network management device comprising:
failure influence calculation circuitry configured to calculate, for each of a plurality of buildings corresponding to an upper layer of a network, an influence of a failure in communication including an occurring failure and an influence of the occurring failure on another building corresponding to a lower layer of the network when a condition that the failure occurs in communication in one of the buildings corresponding to the upper layer of the network and each accommodating a communication facility is applied; and
priority calculation circuitry configured to calculate, for each combination of a plurality of buildings in which the failure has occurred, a priority of a candidate for a building to be restored from the failure among a plurality of buildings when a condition that the failure occurs in communication in the plurality of buildings corresponding to the upper layer is applied on a basis of the influence calculated by the failure influence calculation circuitry.

2. The network management device according to claim 1, wherein the failure influence calculation circuitry is further configured to:
calculate, for each of buildings corresponding to the upper layer, an influence of a failure in the communication corresponding to the occurring failure and the lower layer of the network and including an influence of the occurring failure on a building corresponding to the upper layer and capable of communicating with another building other than a building in which the failure has occurred.

3. The network management device according to claim 2, wherein the failure influence calculation circuitry is further configured to:
calculate, for each of buildings corresponding to the upper layer, an influence of a failure in the communication including an influence of the occurring failure on a building corresponding to the occurring failure and a lower layer of the network due to the occurring failure and not communicating with the another building in the upper layer, and an influence of the occurring failure on a building corresponding to a lower layer of the network and capable of communicating with the another building in the upper layer.

4. The network management device according to claim 1, further comprising:
a plan processing circuitry configured to plan a work of restoring the occurring failure on a basis of a condition related to a work of restoring the failure with respect to the building corresponding to the priority calculated by the priority calculation circuitry.

5. The network management device according to claim 1, wherein:
the failure influence calculation circuitry is further configured to calculate, for each of buildings corresponding to the upper layer, an influence of a failure in the communication including the occurring failure and an influence of the occurring failure on another building corresponding to the lower layer when a condition that the failure occurs due to a stop of power supply to a communication facility accommodated in one of a plurality of buildings corresponding to the upper layer is applied, and
the priority calculation circuitry is further configured to calculate, for each combination of a plurality of buildings in which the failure has occurred, a priority of a candidate for a building for which power supply is to be restored among a plurality of buildings when a condition that power supply to communication facilities accommodated in the plurality of buildings corresponding to the upper layer stops is applied on a basis of the influence calculated by the failure influence calculation circuitry.

6. The network management device according to claim 4, wherein the plan processing circuitry is further configured to:
plan information indicating a vehicle to be actually allocated to a building and a movement route of the vehicle to the building on a basis of information related to the failure in the building and information related to a candidate for a vehicle to be allocated for a work of restoring the failure for the building while prioritizing a building having a higher priority calculated by the priority calculation circuitry.

7. A network management method, comprising:
calculating, for each of a plurality of buildings corresponding to an upper layer of a network, an influence of a failure in communication including an occurring failure and an influence of the occurring failure on another building corresponding to a lower layer of the network when a condition that the failure occurs in communication in one of the buildings corresponding to the upper layer of the network and each accommodating a communication facility is applied; and
calculating, for each combination of a plurality of buildings in which the failure has occurred, a priority of a candidate for a building to be restored from the failure among a plurality of buildings when a condition that the failure occurs in communication in the plurality of buildings corresponding to the upper layer is applied on a basis of the calculated influence.

8. A non-transitory computer readable medium storing computer instructions of a network management processing program for causing a processor to function as each of the circuitries of the network management device according to claim 1.

9. A non-transitory computer readable medium storing computer instructions of a network management processing program for causing a processor to perform the method of claim 7.
